(19) United States
(12) Patent Application Publication
(10) Pub. No.: US 2024/0370226 A1
(43) Pub. Date: Nov. 7, 2024

(54) SYSTEM AND METHOD FOR DETERMINING AN URGENT EVENT AND NOTIFYING A USER

(71) Applicant: Rebecca Schwarzberg LLC, Palm Beach Gardens, FL (US)

(72) Inventors: Rebecca Miryam Schwarzberg, Palm Beach Gardens, FL (US); Aden Eagle, Palm Beach Gardens, FL (US)

(73) Assignee: Rebecca Schwarzberg LLC, Palm Beach Gardens, FL (US)

(21) Appl. No.: 18/143,800

(22) Filed: May 5, 2023

(51) Int. Cl. G06F 3/16; G06F 3/01; G06F 16/65

(52) U.S. Cl. CPC G06F 3/167; G06F 3/016; G06F 16/65

(57) ABSTRACT

According to some embodiments, an event detection system is provided to detect sounds indicative of an urgent event and communicate to the user, through visual and/or haptic feedback, the existence of the event. In some embodiments, the event detection system can also communicate a classification for the event. In some embodiments, the classification can indicate a level of severity or danger to the user or another person. In some embodiments, the event detection system can include a user equipment (UE), an external visual feedback device, and/or an external haptic feedback device.

This disclosure includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE DISCLOSURE

The present disclosure relates generally to improving the performance of event detection systems by modifying the capabilities of and providing non-native functionality to devices, systems and/or platforms through a novel and improved framework for developing and training audio detection models and applying them to real-time data sources.

### BACKGROUND

Navigating the built environment can be challenging and even downright dangerous for persons with a lack of auditory capacity. The increased density in urban and sub-urban areas is naturally accompanied by an increase in interactions that require people to be aware of the sounds around them. This can be particularly challenging in the operation of vehicles in general, and motor vehicles in particular, because of the speed at which circumstances develop and the response times required from the users. At least from an auditory perspective, hearing-impaired users do not perceive the world as quickly, or as well, as others around them. Often, they require assistance and additional time to process the same information, failing which, they expose themselves and others to increased peril. Traditional solutions found in the art fail to provide granular or otherwise precise and timely translations of the soundscape into visual or haptic mediums.

### BRIEF SUMMARY

This disclosure provides a novel framework that alleviates shortcomings in the art, and provides systems and methods for performing cost-effective, accurate, and scalable detection of aural or sound-based warnings and communicating such warnings through different sensory media to a user. In some embodiments, the systems and methods discussed herein allow for the detection of sounds indicative of, among other things, a dangerous or relevant circumstance to a user (e.g., an urgent event) and then, based on said detection, timely communicating to the user the nature of the situation and/or an associated level of severity.

In some aspects, the techniques described herein relate to a method including obtaining, by a user equipment (UE), indicative sound audio data corresponding to an event and segmenting the indicative sound audio data to extract an audio data segment. In some aspects, the method further includes determining a probability that the event is an urgent event by inputting the audio data segment into an urgent event prediction model and determining that the probability is above a predetermined threshold. In some aspects, the method can also include transmitting to an external feedback device a message directing the external feedback device to provide feedback to the user and providing, by the external feedback device, feedback to the user.

In some aspects, the external feedback device can comprise at least one of a light and a display. In some embodiments, providing feedback to the user can comprise at least one of illuminating the light in a specific color and displaying a string of text in the display.

In some aspects, the external feedback device can comprise a head-mounted augmented reality/virtual reality (AR/VR) device with a display. In some embodiments, providing feedback to the user can comprise displaying at least one of a string of text or multimedia in the display of the AR/VR device.

In some aspects, the external feedback device can comprise at least one of an eccentric rotating mass (ERM) vibration motor, a microelectromechanical systems (MEMS), and a tactile display.

In some aspects, the method can further include determining a severity level corresponding to the urgent event by inputting the audio data segment into a severity classification model.

In some aspects, the message to the external feedback device can include instructions to illuminate the light in specific color and display a string of text in the display, where the specific color and the string of text are associated with the severity level.

In some aspects, the message to the external feedback device can include instructions to reproduce a haptic pattern.

In some aspects, the techniques described herein relate to a non-transitory computer-readable storage medium for storing instructions executable by a processor, the instructions comprising obtaining, by a user equipment (UE), audio data corresponding to an event and segmenting the audio data to extract an audio data segment. In some aspects, the instructions further comprise determining a probability that the event is an urgent event by inputting the audio data segment into an urgent event prediction model and determining that the probability is above a predetermined threshold. In some aspects, the instructions can also include transmitting to at an external feedback device a message directing the external feedback device to provide feedback to the user.

In some aspects, the techniques described herein relate to a device comprising a processor configured to: obtain indicative sound audio data corresponding to an event; segment the indicative sound audio data to extract an audio data segment; determine a probability that the event is an urgent event by inputting the audio data segment into an urgent event prediction model and determining that the probability is above a predetermined threshold; and transmit to an external feedback device a message directing the external feedback device to provide feedback to a user.

In some aspects, the device can be communicatively coupled to at least one of the external visual feedback device and the external haptic feedback device using Bluetooth®.

### DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a diagram illustrating components of an event detection system according to some embodiments.

FIG. 2 is a block diagram illustrating components of an event detection engine according to some embodiments.

FIG. 3A and FIG. 3B are flow diagrams illustrating a method for detecting an urgent event and providing feedback to a user according to an embodiment.

FIG. 4 is a flow diagram illustrating a method for training an urgent event detection model and a severity classification model according to an embodiment.

FIG. 5 is a block diagram of a device according to some embodiments.

### DETAILED DESCRIPTION

According to some embodiments, an event detection system is provided to detect sounds indicative of an urgent event and communicate to the user, through visual and/or haptic feedback, the existence of the event. In some embodiments, the event detection system can also communicate a classification for the event. In some embodiments, the classification can indicate a level of severity or danger to the user or another person. While the present disclosure describes feedback to a user with respect to visual and haptic feedback, it is not so limited. In some embodiments, the event detection system described herein can provide feedback to a user in any manner and through any means capable of drawing a user's attention or otherwise communicating information to a user, without departing from the scope of the present disclosure.

In some embodiments, the indicative sound can be any type of sound, whether natural or man-made, irrespective of the frequency range of said sound. For example, in some embodiments, man-made indicative sounds can include police, fire, or first responder sirens; vehicle (e.g., cars, trains, watercraft, bicycles) horns; sounds from the operation of a vehicle (e.g., revving engine noises, tire screeching); warning or attention sounds (e.g., railroad crossings, bells, whistles (irrespective of frequency), announcements over a Public Announcement (PA) system, and/or fire, carbon dioxide, or smoke alarm). In some embodiments, natural indicative sounds can include shouts or screams from a human and/or noises from animals (e.g., barking from dogs). In some embodiments, indicative sounds can include any sound or pressure wave intended to call a user's attention. In some embodiments, indicative sounds can be classified based on a hierarchy of urgency or danger to the user. For example, in some embodiments, screams or train and car horns may take precedence over sirens and train crossings warning sounds.

In some embodiments, the event detection system can provide the user with visual feedback. In some embodiments, to provide visual feedback the event detection system can include lights, displays, and/or augmented reality/virtual reality (AR/VR) devices (e.g., wearable AR/VR goggles). In some embodiments, the event detection system can provide the user with haptic feedback. In some embodiments, to provide haptic feedback the event detection system can include tactile or force-feedback devices that can simulate textures, temperatures, and/or resistance. For example, in some embodiments, the event detection system can include one or more electromechanical haptic motors and/or tactile displays.

In some embodiments, the event detection system can implement urgent event prediction models and/or severity classification models to analyze audio data corresponding to indicative sounds to determine the existence or presence of an urgent event and an urgency or severity level corresponding to the urgent event, respectively. In some embodiments, the urgent event prediction models and/or the severity classification models can intake spectrograms or other representations of audio data and generate predictions or classifications, respectively, based on the audio data representation.

In some embodiments, at least one of the urgent event prediction model and the severity classification model can include a convolutional neural network or some other artificial intelligence (AI)/machine learning technique to perform prediction or classification. For example, in some embodiments, at least one of the urgent event prediction models and the severity classification models can be a convolutional neural network including two-dimensional convolutional layers interspersed with maximum pooling layers. In some of those embodiments, the outputs of each convolutional layer can be activated using a rectified linear unit activation function (ReLU). In some embodiments, the outputs can be further flattened into a tensor of rank one. In some embodiments, the outputs of the convolution layers can be connected to an output layer activated by a sigmoid activation function. In some embodiments, urgent event prediction models and/or severity classification models can have parameters (e.g., weights) determining the overall performance of the model. In some of those embodiments, the models can be optimized using Bayesian optimization.

Certain embodiments will now be described in greater detail with reference to the figures.

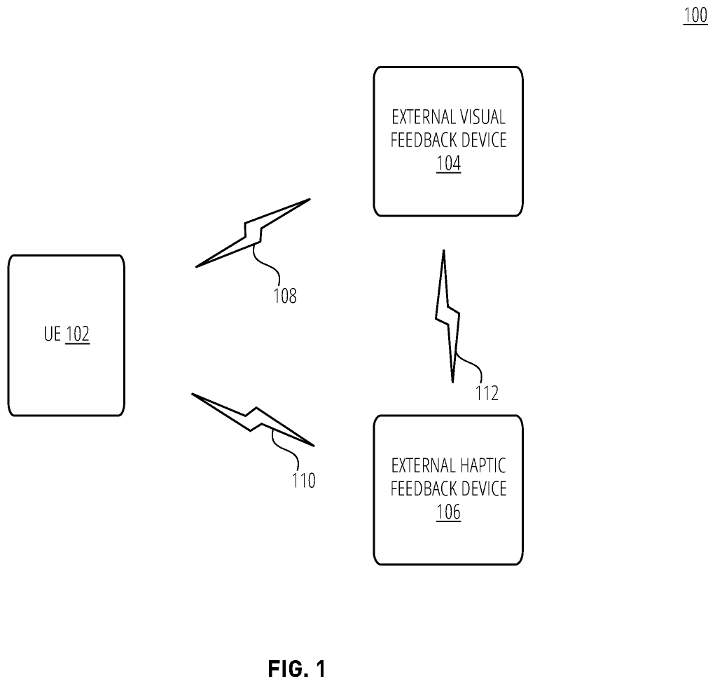

FIG. 1 is a diagram illustrating components of an event detection system according to some embodiments.

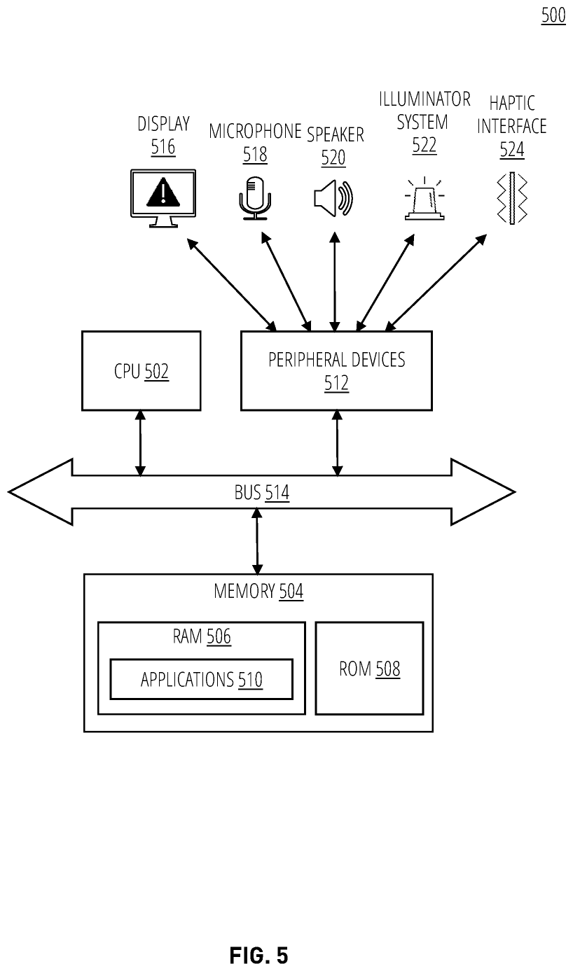

According to some embodiments, an event detection system 100 can include a user equipment (UE) 102, an external visual feedback device 104, and/or an external haptic feedback device 106. However, not all components may be used. In some embodiments, the UE 102 can perform urgent event detection as described herein and warn or otherwise provide information to the user about the urgent event using visual feedback device 104 and/or haptic feedback device 106. In some embodiments, UE 102 can determine the existence of an urgent event, a type of event, an urgency or severity level associated with the urgent event, evasive or corrective action with respect to the event, and/or other relevant information by detecting and analyzing indicative sounds. In some embodiments, UE 102 can be a device 500 as discussed with respect to FIG. 5. No limit is placed on the type of UE. For example, in some embodiments, UE 102 can be an autonomous vehicle computing device, an intern-of-things (IoT) device, a smartphone, a tablet, a wearable device (e.g., AR/VR goggles or smart watches), and/or a smart speaker. In some embodiments, UE 102 can capture indicative sounds using a microphone (e.g., microphone 518) or some other sensor.

In some embodiments, visual feedback device 104 can provide the user with a visual indication or otherwise communicate information visually to the user. In some embodiments, visual feedback device 104 can be a device 500 as discussed with respect to FIG. 5. In some embodiments, the visual feedback device 104 can include an illuminator system (e.g., illuminator system 522) and/or one or more displays (e.g., display 516). In some embodiments, the illuminator system can include discrete lights and/or addressable red, blue and green (RGB) lights (e.g., Light Emitting Diodes (LEDs) light strips). In some embodiments, visual feedback device 104 can include a head-mounted augmented reality/virtual reality (AR/VR) device (e.g., AR/VR goggles). In some of those embodiments, visual feedback device 104 can provide feedback to the user by displaying a string of text and/or multimedia to the user.

In some embodiments, visual feedback device 104 can have more than one method of visually communicating information to the user. In some of those embodiments, each method can communicate different information to the user. For example, in some embodiments, visual feedback device 104 can include warning lights as part of the illuminator system, a display, and AR/VR goggles. In those embodiments, the warning lights can indicate a severity level associated with an event while the displays and/or AR/VR goggles communicate the type of event in a string of text or through multimedia (e.g., an image associated with or depicting the urgent event).

In some embodiments, haptic feedback device 106 can provide the user with haptic feedback or otherwise mechanically communicate information to the user. In some embodiments, haptic feedback device 106 can be a device 500 as discussed with respect to FIG. 5. In some embodiments, the haptic feedback device 106 can include a haptic interface (e.g., haptic interface 524). In some embodiments, a haptic interface can include one or more electromechanical devices (e.g., eccentric rotating mass (ERM) vibration motors), microelectromechanical systems (MEMS), and/or tactile displays. For example, in some embodiments, haptic feedback device 106 can include a vibration pad that lays on top of a seat. In some embodiments, haptic feedback device 106 can be part of a car seat or steering wheel.

In some embodiments, at least one of visual feedback device 104 and haptic feedback device 106 can provide feedback to the user using mechanical pressure waves from a transducer or speaker. In those embodiments, the pressure waves may not be heard by the user through the user's auditory system but rather felt as vibrations.

In some embodiments, visual feedback device 104 and haptic feedback device 106 can be implemented in a single device. For example, in some embodiments, visual feedback device 104 and haptic feedback device 106 can be implemented in a head-mounted AR/VR device and include an illuminator system, a display, and a haptic interface.

In some embodiments, at least one of UE 102, visual feedback device 104, and haptic feedback device 106 is communicatively coupled to at least one other of UE 102, visual feedback device 104, and haptic feedback device 106 through communications links 108-112. In some embodiments, UE 102 can communicate with visual feedback device 104 and/or haptic feedback device 106 to direct either device to warn or otherwise provide information to the user. In some embodiments, at least one of visual feedback device 104 and haptic feedback device 106 can capture indicative sounds and provide said sounds to the UE 102 for analysis and urgent event detection. In some of those embodiments, UE 102 can receive and analyze the indicative sounds, and based on said analysis direct at least one visual feedback device 104 and/or haptic feedback device 106 to provide feedback to the user. In some embodiments, two of UE 102, visual feedback device 104, and haptic feedback device 106 can be part of the same device.

In some embodiments, UE 102 can transmit messages to at least one of visual feedback device 104 and haptic feedback device 106 indicating the existence of an urgent event, a type of event, an urgency or severity level associated with the urgent event, evasive or corrective action with respect to the event or other relevant information.

In some embodiments, the message can include any level of information granularity desired to be communicated to the user. For example, in some embodiments, the message can include a severity or severity level indication (e.g., LOW, SEMI-URGENT, URGENT). In some embodiments, the severity level indication can be associated with a level of attention required from the user. For example, in some embodiments, a LOW severity level can refer to an event that can be disregarded or does not present an impending danger. In some embodiments, a SEMI-URGENT severity level can refer to an event that requires attention but is not critical to the wellbeing of the user. In some embodiments, an URGENT severity level can refer to an event that requires immediate attention from the user. In some embodiments, if disregarded, an URGENT level event can result in direct harm to the user.

In some embodiments, the message can include one or more indication colors corresponding to a given severity level (e.g., green for LOW, amber for SEMI-URGENT, or red for URGENT). It will be appreciated that the present disclosure is not limited to any particular indication color scheme. In some embodiments, event detection system can have functionality to allow a user to select a preferred or desired indication color scheme. In some embodiments, the message can include a string of text to be displayed in a display (e.g., of visual feedback device 104) conveying information regarding the urgent event. For example, in some embodiments, the text can indicate a source of the indicative sound (e.g., “Scream”, “Car Honk”, “Train Horn”, “Siren”, “Train Crossing”). In some embodiments, the string of text can be associated with an illumination color in the message. For example, in some embodiments, visual feedback device 104 can display the text strings “Scream”, “Car Honk”, or “Train Horn” while illuminating warning lights in red to indicate an URGENT severity level. In some other embodiments, visual feedback device 104 can display the text strings “Siren” or “Train Crossing” while illuminating warning lights in amber to indicate a SEMI-URGENT severity level. In some embodiments, the message can include multimedia (e.g., images or video) associated with the urgent event (e.g., warning signs, icons). In some embodiments, when no urgent event exists or a determined urgent event has a LOW severity level, visual feedback device 104 can illuminate the warning lights in a neutral color (e.g., green) to indicate that it is active but the user should not be alarmed. In some embodiments, visual feedback device 104 can also provide status information of the device (e.g., battery level) using the lighting system and/or a display.

In some embodiments, the message can include a haptic pattern (e.g., sequence of vibrations) to be played or reproduced to the user by the haptic feedback device 106. In some embodiments, specific haptic patterns can be associated with specific severity levels. In some embodiments, haptic patterns can have a frequency (e.g., number of vibrations in a period of time) and an amplitude (e.g., an energy level). In some embodiments, the frequency and amplitude of haptic patterns can be selected to match a severity level. For example, in some embodiments, longer frequency, lower amplitude vibrations can be selected for a SEMI-URGENT severity level; and higher frequency, higher amplitude vibrations can be selected for an URGENT severity level.

In some embodiments, the color schemes, text or multimedia, haptic patterns, and/or any other data that may be used to provide feedback to the user can be stored in the respective one of visual feedback device 104 or haptic feedback device 106 or obtained by visual feedback device 104 and/or haptic feedback device 106 from a database prior to or during runtime. In some of those embodiments, the message can include information regarding the urgent event (e.g., type or severity level) and the visual feedback device 104 or haptic feedback device 106 can determine what color schemes to adopt (e.g., illuminate), text or multimedia to display, or haptic pattern to reproduce.

In some embodiments, messages between UE 102, visual feedback device 104, and/or haptic feedback device 106 can include control information where one device instructs at least one other device to perform an action (e.g., turn on or off or display information). In some embodiments, the messages can include information regarding device status, types and parameters for communications protocols, or any information necessary to establish and maintain communications between devices or with other communications infrastructure (e.g., modems, routers, servers, base stations, and the like). In some embodiments, UE 102, visual feedback device 104, and haptic feedback device 106 can adopt a dedicated communications protocol to communicate with each other. In those embodiments, the messages between UE 102, visual feedback device 104, and haptic feedback device 106 can be specific to the dedicated communications protocol.

In some embodiments, communications links 108-112 can be wired or wireless. In some embodiments, two or more of UE 102, visual feedback device 104, and haptic feedback device 106 can communicate over Ethernet. In some embodiments, two or more of UE 102, visual feedback device 104, and haptic feedback device 106 can communicate using a cellular network or a Wi-Fi network. In some embodiments, two or more UE 102, visual feedback device 104, and haptic feedback device 106 can communicate over a short-range wireless technology such as Bluetooth® or ZigBee®.

In some embodiments, one or more of UE 102, visual feedback device 104, and haptic feedback device 106 can act as nodes in a wireless communications network such as mesh networks. In some of those embodiments, at least one of UE 102, visual feedback device 104, and haptic feedback device 106 can relay communications between the other two. For example, in some embodiments, where UE 102 is directly communicating with visual feedback device 104, UE 102 can transmit a message to haptic feedback device 106 through visual feedback device 104. In those embodiments, visual feedback device 104 can receive the message, determine that it is intended for haptic feedback device 106, and forward the message to haptic feedback device 106. In some embodiments, where at least one of UE 102, visual feedback device 104, and haptic feedback device 106 is a UE of a cellular network, the at least one of UE 102, visual feedback device 104, and haptic feedback device 106 can be communicatively coupled to a base station (e.g., eNodeB or gNodeB) of a Radio Access Network (RAN).

According to some embodiments, the event detection system can be implemented as part of a vehicle. For example, in some embodiments, UE 102 can be a mobile device of a user, visual feedback device 104 can be part of the infotainment system of the vehicle or it can be a standalone device where the illuminator system and/or the displays are within the user's line of sight, and the haptic feedback device 106 can be integrated into the steering wheel, the driver's seat or as a standalone device (e.g., a mat placed over the driver's seat). In the embodiments where visual feedback device 104 and/or haptic feedback device 106 are standalone devices, each of visual feedback device 104 and haptic feedback device 106 can be battery powered or connected to the vehicle's onboard power supply. In some embodiments, the user's mobile device can perform indicative sound detection (e.g., using an integrated microphone) and analysis to determine whether an urgent event is occurring and communicate with at least one of visual feedback device 104 and/or haptic feedback device 106 to provide visual or haptic feedback, respectively, to the user, as described herein.

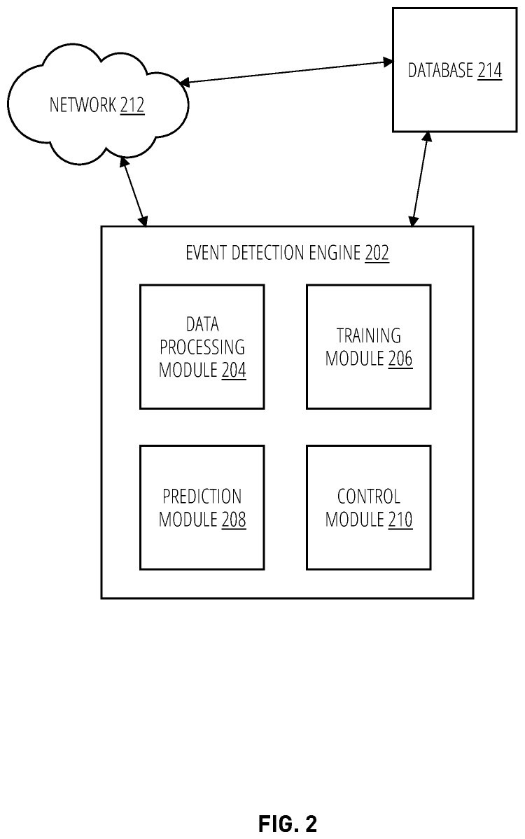

FIG. 2 is a block diagram illustrating components of an event detection engine according to some embodiments.

FIG. 2 illustrates components that can be used for performing the systems and methods discussed herein. However, not all components may be used. FIG. 2 includes event detection engine 202, network 212, and database 214. In some embodiments, the event detection engine 202 can be a special purpose machine or processor and could be hosted by a cloud server (e.g., cloud web services server(s)), application server, content server, web server, search server, content provider, third party server, user's computing device, and the like, or any combination thereof.

According to some embodiments, event detection engine 202 can be a stand-alone application that executes on a device (e.g., UE 102, device 500). In some embodiments, event detection engine 202 can function as an application installed on the device, and in some embodiments, such application can be a web-based application accessed by the device over a network. In some embodiments, portions of the event detection engine 202 function as an application installed on the device and some other portions can be cloud-based or web-based applications accessed by the device over a network, where the several portions of the event detection engine 202 exchange information over the network. In some embodiments, the event detection engine 202 can be installed as an augmenting script, program or application (e.g., a plug-in or extension) to another application or portable data structure.

The database 214 can be any type of database or memory, and can be associated with a content server on a network (e.g., content server, a search server or application server) or a device (e.g., UE 102 or device 500). In some embodiments, database 214 can include a dataset of data and metadata associated with local and/or network information related to users, services, applications, content and the like. In some embodiments, database 214 can include a dataset of data and metadata corresponding to known indicative sounds associated with known events. In some embodiments, the known events can be urgent events or non-urgent events. In some embodiments, the known events can be events with a LOW, SEMI-URGENT, or URGENT severity levels.

In some embodiments, such information can be stored and indexed in the database 214 independently and/or as a linked or associated dataset. It should be understood that the data and metadata in the database 214 can be any type of information and type, whether known or to be known, without departing from the scope of the present disclosure. In some embodiments, datasets as discussed herein can be stored in or embodied by database 214.

According to some embodiments, database 214 can store data and metadata associated with users, messages, images, videos, text, products, color schemes, items and services from an assortment of media, applications and/or service providers and/or platforms, and the like.

According to some embodiments, the network 212 can be any type of network such as, but not limited to, a wireless network, a local area network (LAN), wide area network (WAN), a mesh network, the Internet, or a combination thereof. In some embodiments, the network 212 facilitates connectivity of the event detection engine 202, and database 214. Indeed, as illustrated in FIG. 2, the event detection engine 202 and database 214 can be directly connected by any known or to be known method of connecting and/or enabling communication between such devices and resources.

The principal processor, server, or combination of devices that comprise hardware programmed in accordance with the special purpose functions herein is referred to for convenience as event detection engine 202, and includes data processing module 204, training module 206, prediction module 208, and control module 210. In some embodiments, data processing module 204 can process and analyze indicative sounds as discussed herein. In some embodiments, training module 206 can train urgent event prediction models and/or severity classification models as discussed herein. In some embodiments, prediction module 208 can provide predictions using urgent event prediction models and/or severity classification models as discussed herein. In some embodiments, control module 210 can communicate with external feedback devices (e.g., visual feedback device 104 or haptic feedback device 106) as discussed herein.

It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

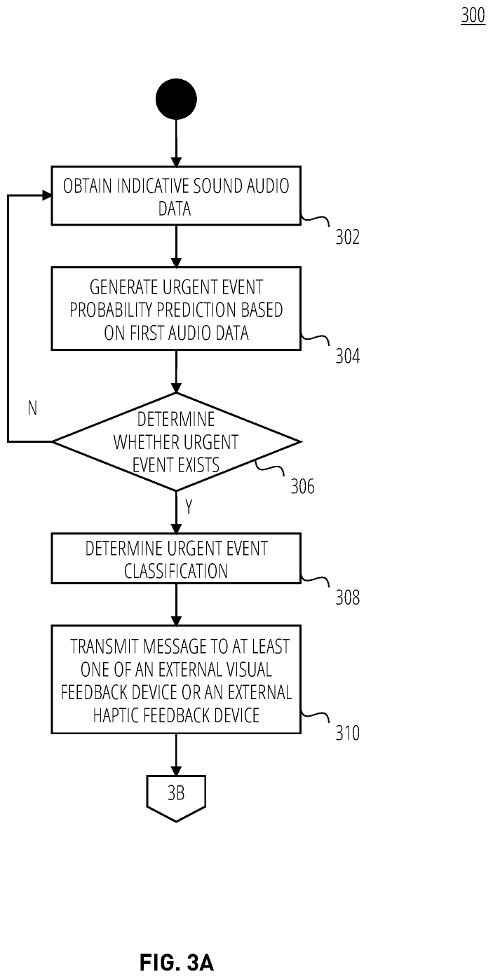

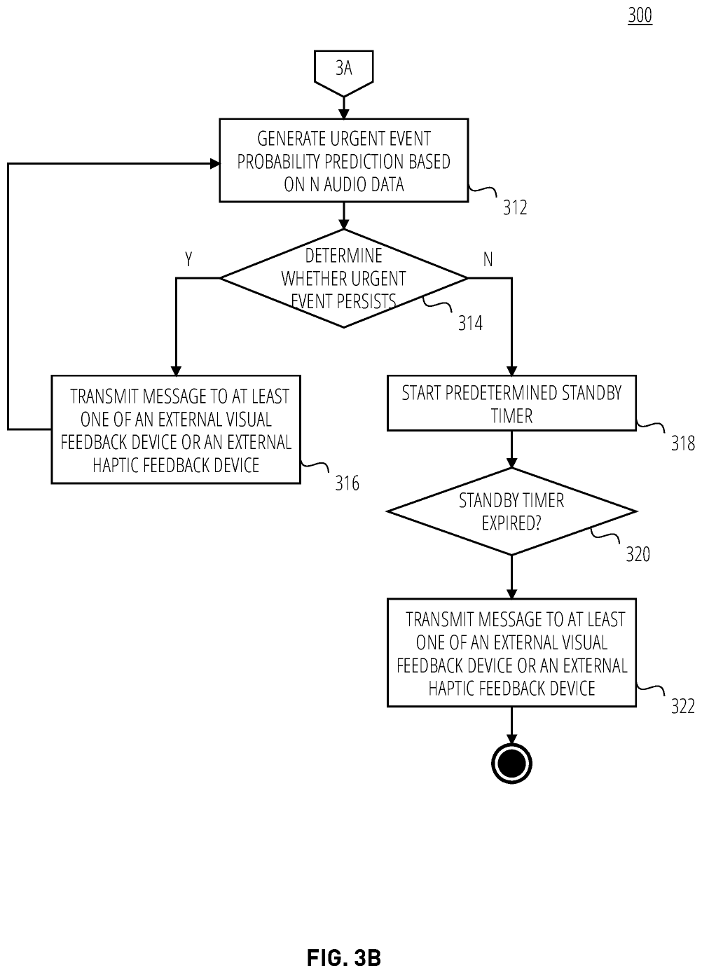

FIG. 3A and FIG. 3B are flow diagrams illustrating a method for detecting an urgent event and providing feedback to a user according to an embodiment.

In Step 302, method 300 can include obtaining indicative sound audio data. In some embodiments, the indicative sound can be associated with an event, which may or may not be an urgent event. In some embodiments, the audio data can be obtained by data processing module 204 of event detection engine 202. In some of those embodiments, event detection engine 202 can be implemented, at least in part, on UE 102 and the audio data can be captured using a microphone of UE 102 and stored for use by data processing module 204. In some embodiments, data processing module 204 can segment the audio data to extract non-overlapping segments or bins. In some embodiments, the bins can have a predetermined length. In some embodiments, the predetermined length is two (2) seconds. In some embodiments, the predetermined length can be longer than 2 seconds.

In Step 304, method 300 can include obtaining a first audio data segment or first batch of audio data segments and generating an urgent event probability prediction based on the first audio data segment or first batch of audio data segments. In some embodiments, a batch of audio data segments includes a predetermined number of segments (e.g., 10 segments) or a number of segments within a predetermined period of time (e.g., 15 segments in a 30 second period where each segment is 2 seconds).

In some embodiments, data processing module 204 can obtain the first audio data segment and determine a spectrogram representation of the audio data. In some embodiments, the spectrogram representation can correspond to a mel spectrogram. In some embodiments, the spectrogram representation can be determined using known methods such as the NumPy numerical computing and linear algebra package for Python. In some of those embodiments, the decibel levels can be scaled to values between 0 and 1 for efficient processing. Then, in some embodiments, prediction module 208 can input the mel spectrogram into an urgent event prediction model to generate a probability corresponding to a likelihood that the indicative sound corresponds to an urgent event. In some embodiments, the urgent event prediction model can generate probabilities for a plurality of potential urgent events. In some embodiments, the generated probability can be indicative of a severity level corresponding to the urgent event associated with the indicative sound.

In some embodiments where the urgent event probability prediction is based on a batch of audio segments, data processing module 204 can obtain each segment in the batch and determine the mel spectrogram for each segment. Then, in some embodiments, prediction module 208 the urgent event prediction model to the spectrograms and determine an urgent event probability prediction for each segment. In some embodiments, the probabilities are averaged to determine an average probability for each urgent event of the plurality of potential urgent events. In those embodiments, the urgent events can be ranked based on the averaged probabilities. In some embodiments, the highest probability for each urgent event is selected and the urgent events are ranked based on the highest probability of any given audio data segment.

In Step 306, method 300 can include determining whether an urgent event exists based on the urgent event prediction. In some embodiments, control module 210 can determine whether the urgent event exists based on whether the generated prediction is above a predetermined threshold. In some embodiments, the predetermined threshold can be an arbitrary threshold (e.g., above 80%). In some embodiments, the predetermined threshold can be experimentally determined. In some embodiments, the predetermined threshold can be the urgent event with the highest probability in a ranked list of potential urgent events and associated probabilities as determined in Step 304. If the generated prediction is above the predetermined threshold, then method 300 continues to Step 308. If not, then method 300 can return to Step 302 and restart the process.

In Step 308, method 300 can include determining a severity or severity level associated with the urgent event. In some embodiments, prediction module 208 can input the mel spectrogram corresponding to the first audio data segment to a severity classification model to determine a classification for the urgent event (e.g., LOW, SEMI-URGENT, URGENT).

In Step 310, method 300 can include transmitting a message to at least one of an external visual feedback device (e.g., visual feedback device 104) and an external haptic feedback device (e.g., haptic feedback device 106) to provide feedback to a user corresponding to the urgent event. In some embodiments, the message can be transmitted by control module 210. In some embodiments, the message can be a message as discussed in relation to FIG. 1. In some embodiments, the message can direct at least one of the external feedback devices to communicate the existence of the urgent event or other information regarding the urgent event (e.g., urgency or danger/severity level) to the user. In some embodiments, in Step 310, the control module 210 can determine (e.g., by searching database 214) an evasive or corrective action associated with the event. In some embodiments, the evasive or corrective action can be associated with the corresponding urgent event in database 214.

In Step 312, method 300 can include obtaining an N audio data segment or N batch of audio data segments and generating an urgent event probability prediction based on the N audio data segment or N batch of audio data segments. In some embodiments, similar to Step 304, data processing module 204 can obtain the N audio data segment or batch of segments, determine the mel spectrograms, and input the mel spectrograms to the urgent event prediction model to generate urgent event probabilities.

In Step 314, method 300 can include determining whether the urgent event persists based on the urgent event prediction. In some embodiments, similar to Step 306, control module 210 can determine whether the urgent event persists based on whether the generated prediction is above the predetermined threshold. If so, method 300 continues to Step 316.

In Step 316, method 300 can include retransmitting by control module 210 the message of Step 310 to at least one of the external feedback devices or control module 210 can transmit a new message to the at least one of the external feedback devices to update information regarding the urgent event. In some embodiments, method 300 returns to Step 312 until the urgent event has ceased as determined in Step 314. In some embodiments, Steps 312-316 can be repeated for a predetermined number of segments or if any segment in a preceding predetermined segment window (e.g., the past 3 segments) are above the predetermined threshold.

In Step 318, method 300 can include starting a standby timer for a predetermined period of time. For example, in some embodiments, the predetermined period of time can be six (6) seconds. In Step 320, method 300 can include determining whether the standby timer has expired and, if so, in Step 322, method 300 can include transmitting a message to at least one of the external feedback devices to notify the user that the event has ceased and/or instruct the external feedback devices to stop providing feedback to the user.

Optionally, in some embodiments, during the standby period, method 300 can include repeating Steps 312-314 and if the generated prediction remains below the threshold during the standby period then method 300 proceeds to Step 322. In some embodiments, if the generated prediction rises above the threshold then Steps 312-314 are repeated and the standby timer is reset.

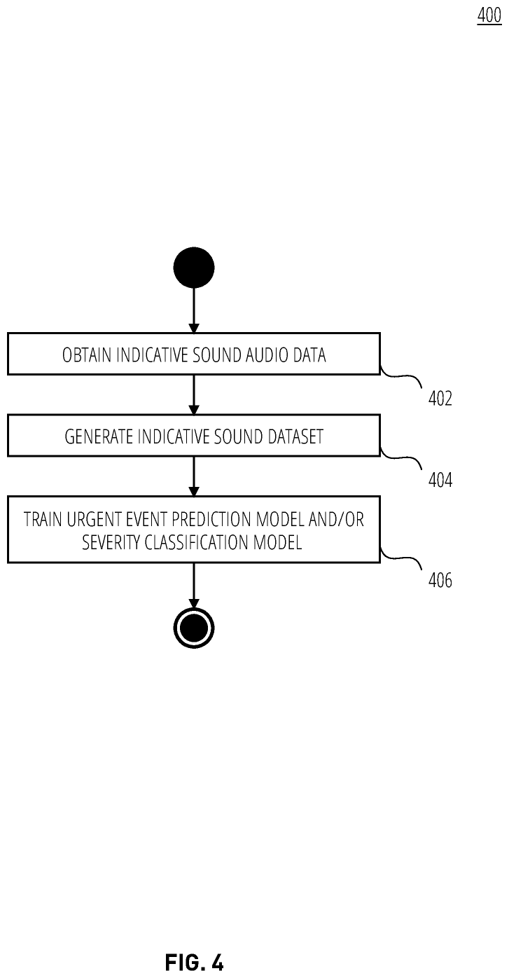

FIG. 4 is a flow diagram illustrating a method for training an urgent event detection model and a severity classification model according to an embodiment.

In Step 402, method 400 can include obtaining an indicative sound dataset. In some embodiments, the indicative sound dataset can be retrieved by the data processing module 204 from the database 214. In some embodiments, the indicative sound dataset can include audio files associated with urgent events. In some embodiments, the indicative sound dataset can include audio files obtained from online repositories or scraped from online sources. In some embodiments, the indicative sound data can include indicative sounds within specific categories (e.g., car horns, police/ambulance sirens, human screams, train crossing indicators, and train horns). In some embodiments, the indicative sound data can include distractor sounds (e.g., normal human speech, thunderstorms, road noise, and normal vehicle noise).

In Step 404, method 400 can include determining a fitting dataset, a calibration dataset, and a test dataset from the indicative sound dataset for each of the urgent event detection model and the severity classification model. In some embodiments, data processing module 204 can derive the fitting dataset, the calibration dataset, and the test dataset from a randomized 70-15-15 split, respectively, of the indicative sound dataset.

In Step 406, method 400 can include training at least one of the urgent event detection model and the severity classification model using the fitting dataset derived in Step 404. In some embodiments, training module 206 can train at least one of the urgent event detection model and the severity classification model. In some embodiments, a cross-entropy loss can be used for training either model. In some embodiments, the model parameters can be updated using the ADAM optimizer. In some embodiments, hyperparameter tuning of the number of convolutional and fully connected layers as well as the number of filters and units in each layer can be performed using Bayesian optimization and five-fold cross-validation. For example, in some of those embodiments, the fitting dataset is split into five equal folds; one of the folds is set as an evaluation dataset and the remaining folds are set as the training dataset. In some embodiments, the training dataset can be further split by randomly selecting 20% of the training dataset as an early stopping dataset with the rest remaining as the training dataset.

In some embodiments, training module 206 can perform training after sampling model hyperparameters using Bayesian optimization and instantiating a model with the given hyperparameters. In some embodiments, following a prespecified number of rounds of Bayesian optimization, training module 206 can select the hyperparameter settings which yielded the best performance and use said settings to instantiate a final model. In some embodiments, training module 206 can use the some or all of the fitting dataset to train the final model. In some embodiments, training module 206 can select a portion of the fitting set as an early stopping set. In some embodiments, the early stopping dataset can be utilized to control a number of training epochs. In some embodiments, after each training epoch, model performance can be determined on the early stopping dataset. In some embodiments, after a predetermined number of consecutive training epochs (e.g., 5 epochs) with no performance improvement on the early stopping dataset, training can be completed and the model finalized. In some embodiments, training module 206 can use the calibration dataset to calibrate the model using temperature scaling such that the output probabilities better approximate real probabilities.

In some embodiments, following training, hyperparameter tuning, and model calibration, training module 206 can determine final evaluation metrics summarizing model performance by evaluating the model on the test dataset. For example, in some embodiments, said metrics can include the classification accuracy, sensitivity, specificity, and expected calibration error. In some embodiments, these metrics can be utilized to tune the decision thresholds of each model to achieve the desired ratio of false positives and false negatives for later classifications.

FIG. 5 is a block diagram of a device according to some embodiments.

As illustrated, the device 500 can include a processor or central processing unit (CPU) such as CPU 502 in communication with a memory 504 via a bus 514. Device 500 can also include one or more input/output (I/O) or peripheral devices 512. Examples of peripheral devices include, but are not limited to, network interfaces, audio interfaces (e.g., microphone 518, speaker 520), display devices or touch screens (e.g., display 516), keypads, mice, keyboard, illuminators (e.g., illuminator system 522), haptic interfaces (e.g., haptic interface 524), global positioning system (GPS) receivers, cameras, or other optical, thermal, or electromagnetic sensors.

In some embodiments, the CPU 502 can comprise a general-purpose CPU. The CPU 502 can comprise a single-core or multiple-core CPU. The CPU 502 can comprise a system-on-a-chip (SoC) or a similar embedded system. In some embodiments, a graphics processing unit (GPU) can be used in place of, or in combination with, a CPU 502. Memory 504 can comprise a non-transitory memory system including a dynamic random-access memory (DRAM), static random-access memory (SRAM), Flash (e.g., NAND Flash), or combinations thereof. In one embodiment, the bus 514 can comprise a Peripheral Component Interconnect Express (PCIe) bus. In some embodiments, bus 514 can comprise multiple busses instead of a single bus.

Memory 504 illustrates an example of non-transitory computer storage media for the storage of information such as computer-readable instructions, data structures, program modules, or other data. Memory 504 can store a basic input/output system (BIOS) in read-only memory (ROM), such as ROM 508, for controlling the low-level operation of the device. The memory can also store an operating system in random-access memory (RAM) for controlling the operation of the device.

Applications 510 can include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device 500 can optionally communicate with a base station (not shown) or directly with another computing device. One or more network interfaces in peripheral devices 512 are sometimes referred to as a transceiver, transceiving device, or network interface card (NIC).

An audio interface in Peripheral devices 512 produces and receives audio signals such as the sound of a human voice or indicative sounds as described herein. For example, an audio interface may be coupled to speaker 520 and microphone 518 to enable telecommunication with users and others, capture sounds, or generate an audio acknowledgment for some action. Displays 516 in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 can comprise any input device arranged to receive input from a user. An illuminator (e.g., illuminator system 522) in peripheral devices 512 can provide a status indication or provide light. The device can also comprise an input/output interface in peripheral devices 512 for communication with external devices, using communication technologies, such as USB, infrared, Bluetooth®, or the like. A haptic interface 524 in peripheral devices 512 can provide a tactile feedback to a user of the device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device can include more or fewer components than those shown in FIG. 5, depending on the deployment or usage of the device. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
obtaining, by a user equipment (UE), audio data corresponding to an event;
segmenting, by the UE, the audio data to extract an audio data segment;
determining, by the UE, a probability that the event is an urgent event by inputting the audio data segment into an urgent event prediction model and determining that the probability is above a predetermined threshold;
transmitting, by the UE to an external feedback device, a message directing the external feedback device to provide feedback to a user; and
providing, by the external feedback device, feedback to the user.

2. The method of claim 1, wherein the external feedback device comprises at least one of a light and a display, and wherein providing feedback to the user comprises at least one of illuminating the light in a specific color and displaying a string of text in the display.

3. The method of claim 1, wherein the external feedback device comprises a head-mounted augmented reality/virtual reality (AR/VR) device with a display, and wherein providing feedback to the user comprises displaying at least one of a string of text or multimedia in the display.

4. The method of claim 1, wherein the external feedback device comprises at least one of an eccentric rotating mass (ERM) vibration motor, a microelectromechanical systems (MEMS), and a tactile display.

5. The method of claim 1, further comprising determining, by the UE, a severity level corresponding to the urgent event by inputting the audio data segment into a severity classification model.

6. The method of claim 5, wherein the external feedback device comprises at least one of a light and a display, wherein the message to the external feedback device includes instructions to illuminate the light in specific color and display a string of text in the display, and wherein the specific color and the string of text are associated with the severity level.

7. The method of claim 5, wherein the message to the external feedback device includes instructions to reproduce a haptic pattern.

8. A non-transitory computer-readable storage medium for storing instructions executable by a processor, the instructions comprising:
obtaining, by a user equipment (UE), audio data corresponding to an event;
segmenting, by the UE, the audio data to extract an audio data segment;
determining, by the UE, a probability that the event is an urgent event by inputting the audio data segment into an urgent event prediction model and determining that the probability is above a predetermined threshold; and
transmitting, by the UE to an external feedback device, a message directing the external feedback device to provide feedback to a user.

9. The non-transitory computer-readable storage medium of claim 8, wherein the message comprises instructions to the external feedback device to perform at least one of illuminating a light in a specific color and to display a string of text in a display.

10. The non-transitory computer-readable storage medium of claim 8, wherein the message comprises instructions to the external feedback device to reproduce a haptic pattern.

11. The non-transitory computer-readable storage medium of claim 8, wherein the instructions further comprise determining, by the UE, a severity level corresponding to the urgent event by inputting the audio data segment into a severity classification model.

12. The non-transitory computer-readable storage medium of claim 11, wherein the message comprises instructions to the external feedback device to illuminate a light in a specific color and to display a string of text in a display, and wherein the specific color and the string of text correspond to the severity level.

13. The non-transitory computer-readable storage medium of claim 11, wherein the message comprises instructions to the external feedback device to reproduce a haptic pattern, and wherein the haptic pattern corresponds to the severity level.

14. A device comprising a processor configured to:
obtain audio data corresponding to an event;
segment the audio data to extract an audio data segment;
determine a probability that the event is an urgent event by inputting the audio data segment into an urgent event prediction model and determining that the probability is above a predetermined threshold; and
transmit to an external feedback device a message directing the external feedback device to provide feedback to a user.

15. The device of claim 14, wherein the message comprises instructions to the external feedback device to perform at least one of illuminating a light in a specific color and to display a string of text in a display.

16. The device of claim 14, wherein the message comprises instructions to the external feedback device to reproduce a haptic pattern.

17. The device of claim 14, wherein the processor is further configured to determine a severity level corresponding to the urgent event by inputting the audio data segment into a severity classification model.

18. The device of claim 17, wherein the message comprises instructions to the external feedback device to illuminate a light in a specific color and to display a string of text in a display, and wherein the specific color and the string of text correspond to the severity level.

19. The device of claim 17, wherein the message comprises instructions to the external feedback device to reproduce a haptic pattern, and wherein the haptic pattern corresponds to the severity level.

20. The device of claim 14, wherein the device is communicatively coupled to the external feedback device using Bluetooth®.
